(19) United States
(12) Patent Application Publication
(10) Pub. No.: US 2021/0103200 A1
(43) Pub. Date: Apr. 8, 2021

(54) WAVELENGTH CONVERTER, OPTICAL COMMUNICATION SYSTEM, AND METHOD FOR ADJUSTING WAVELENGTH CONVERTER

(71) Applicant: FUJITSU LIMITED, Kawasaki-shi (JP)

(72) Inventors: GOJI NAKAGAWA, Sagamihara (JP); Tomoyuki Kato, Yokohama (JP); Tomohiro YAMAUCHI, Kawasaki (JP); YUICHI AKIYAMA, Kawasaki (JP)

(73) Assignee: FUJITSU LIMITED, Kawasaki-shi (JP)

(21) Appl. No.: 17/036,850

(22) Filed: Sep. 29, 2020

(30) Foreign Application Priority Data
Oct. 3, 2019 (JP) 2019-183044

(51) Int. Cl. G02F 2/00

(52) U.S. Cl. CPC G02F 2/004; G02F 2002/006

(57) ABSTRACT

A wavelength converter includes an input port, an optical fiber configured to cause a signal light and an excitation light to interact with each other due to a nonlinear optical effect, the signal light and the excitation light being input to the input port, a stress application mechanism configured to apply stress in a direction crossing a winding direction of the optical fiber, and an output port configured to output a converted light having a wavelength different from wavelengths of the signal light and the excitation light.

### CROSS-REFERENCE TO RELATED APPLICATION

This application is based upon and claims the benefit of priority of the prior Japanese Patent Application No. 2019-183044, filed on Oct. 3, 2019, the entire contents of which are incorporated herein by reference.

### FIELD

The embodiment discussed herein is related to a wavelength converter, an optical communication system, and a method for adjusting a wavelength converter.

### BACKGROUND

One solution for increasing transmission capacity is to increase the number of channels of wavelength division multiplexing (WDM). In addition to a C-band normally used in optical communication, the transmission capacity is increased by using a band (L-band) on a long wavelength side and a band (S-band) on a short wavelength side of the C-band. However, it is difficult to manufacture components having good characteristics such as L-band and S-band optical transmitters and receivers, wavelength multiplexers and demultiplexers, and optical amplifiers compared to C-band components. Thus, cost is high, and it is difficult to implement these components. Accordingly, a technology of expanding a communication band by using inexpensive C-band components having good characteristics and using wavelength conversion has been examined (for example, see Japanese Laid-open Patent Publication No. 2019-70725).

A highly non-linear optical fiber (HNLF) having high matching with an optical fiber is used as a nonlinear optical medium used for the wavelength conversion. The HNLF includes a polarization maintaining fiber (PMF) having a large difference between refractive indices with respect to longitudinal polarized light and transverse polarized light in a cross section orthogonal to a traveling direction, and a non-polarization maintaining fiber (NON-PMF) having substantially the same refractive indices with respect to the longitudinal polarized light and the transverse polarized light, for example, having isotropic refractive indices. In the PMF type HNLF, since a polarization speed in an X direction and a polarization speed in a Y direction are largely different from each other, a propagation delay occurs between polarizations. Similarly, when polarization directions of signal light and excitation light are orthogonal to each other in the wavelength conversion, a nonlinear interaction between the signal light and the excitation light is reduced as the signal light and the excitation light travel through the HNLF, and wavelength conversion efficiency is reduced. Thus, the NON-PM type HNLF is usually used for the wavelength conversion.

Even with the NON-PM type fiber, it is difficult to set a cross-sectional shape of the fiber to be a perfectly isotropic circle, and asymmetry slightly remains. In a fiber mounted on a wavelength converter, anisotropy occurs in the refractive indices due to asymmetric pressure from the outside or torsion. Even the NON-PM type HNLF has slight birefringence due to these factors.

An optical fiber module in which wavelength dispersion characteristics are substantially uniform over a longitudinal direction by applying stress changing in the longitudinal direction to an optical fiber having the wavelength dispersion characteristics changing in the longitudinal direction has been proposed (For example, see Japanese Laid-open Patent Publication No. 2009-294324).

In the above description, Japanese Laid-open Patent Publication No. 2019-70725 and 2009-294324 are disclosed as related art.

### SUMMARY

According to an aspect of the embodiments, a wavelength converter includes an input port, an optical fiber configured to cause a signal light and an excitation light to interact with each other due to a nonlinear optical effect, the signal light and the excitation light being input to the input port, a stress application mechanism configured to apply stress in a direction crossing a winding direction of the optical fiber, and an output port configured to output a converted light having a wavelength different from wavelengths of the signal light and the excitation light.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram for describing wavelength dependence of a PSP;

FIG. 1B is a diagram for describing the wavelength dependence of the PSP;

FIG. 2 is a schematic diagram of an optical transmission system to which a wavelength converter of an embodiment is applied;

FIG. 3 is a graph illustrating changes in wavelength dependence of a DGD due to changes in length and winding diameter of an optical fiber;

FIG. 4 is a schematic diagram of the wavelength converter of the embodiment;

FIG. 5A is a schematic diagram illustrating wavelength conversion using a single beam of excitation light;

FIG. 56 is a schematic diagram illustrating wavelength conversion using two beams of vertical excitation light;

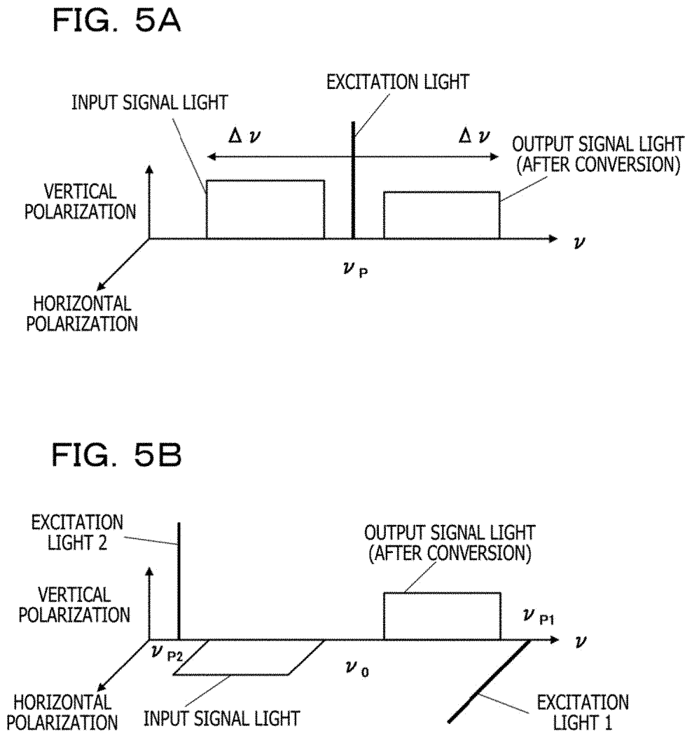

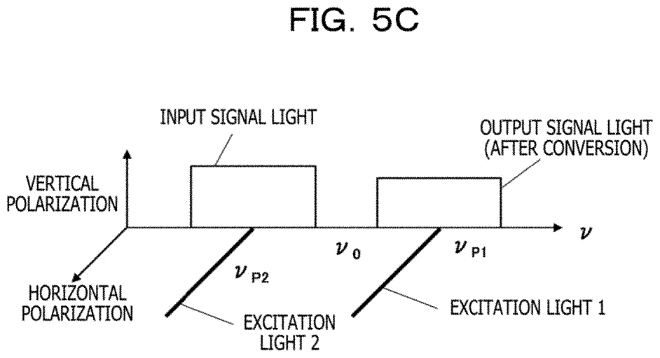

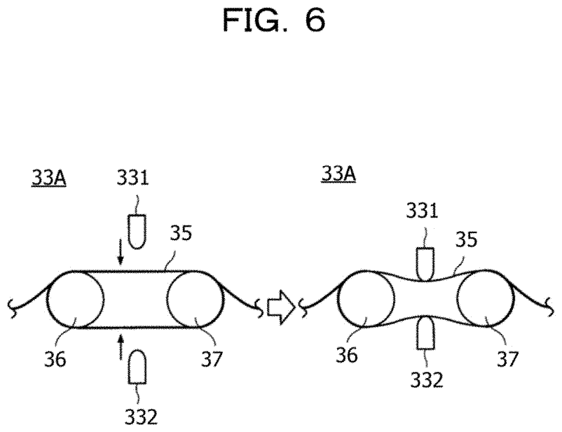

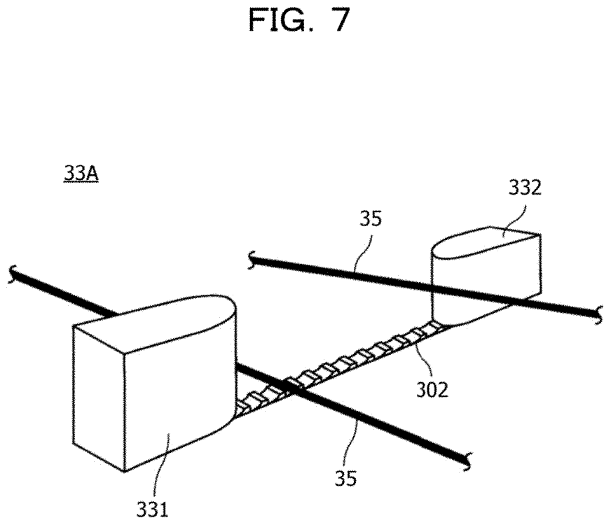

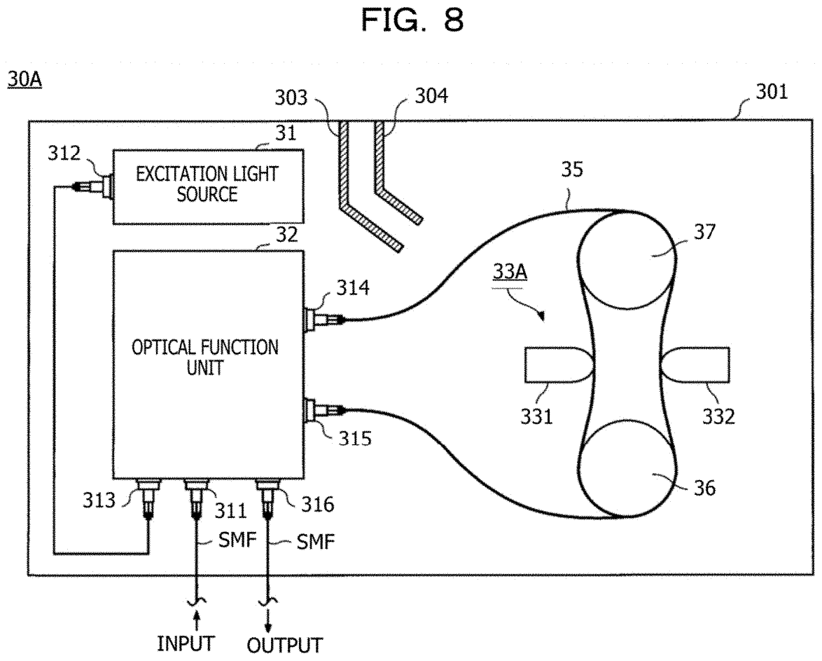

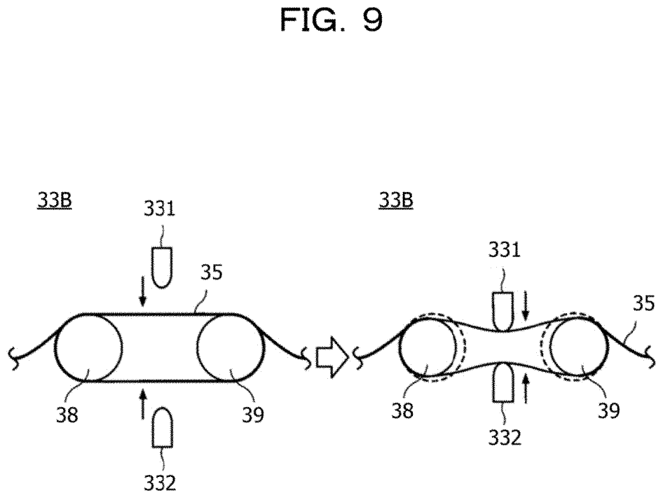

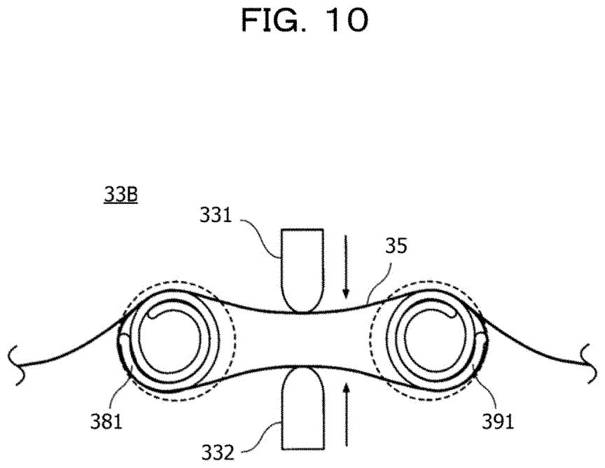

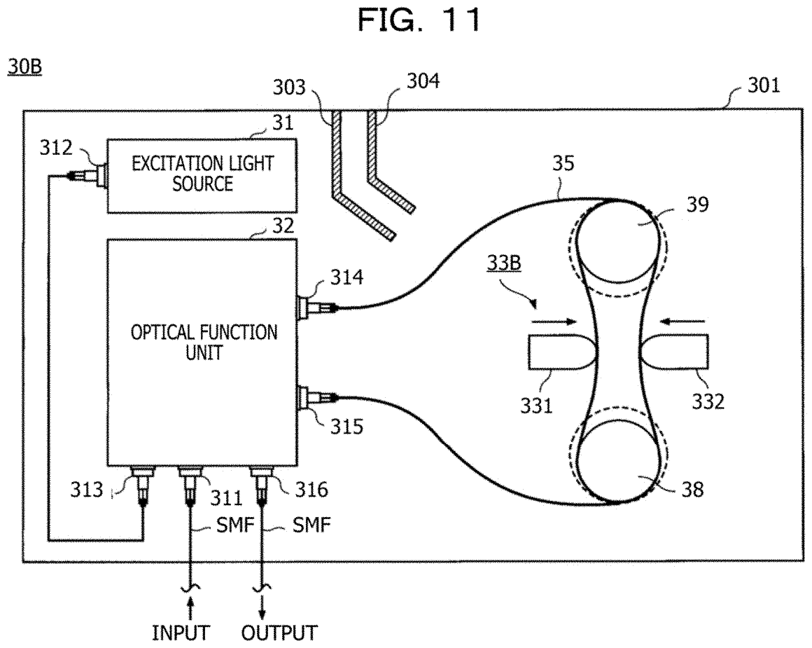

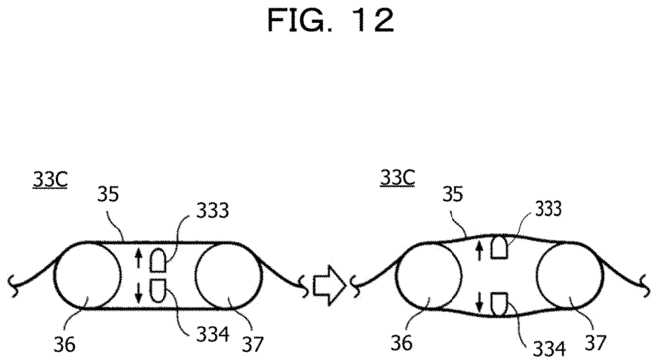

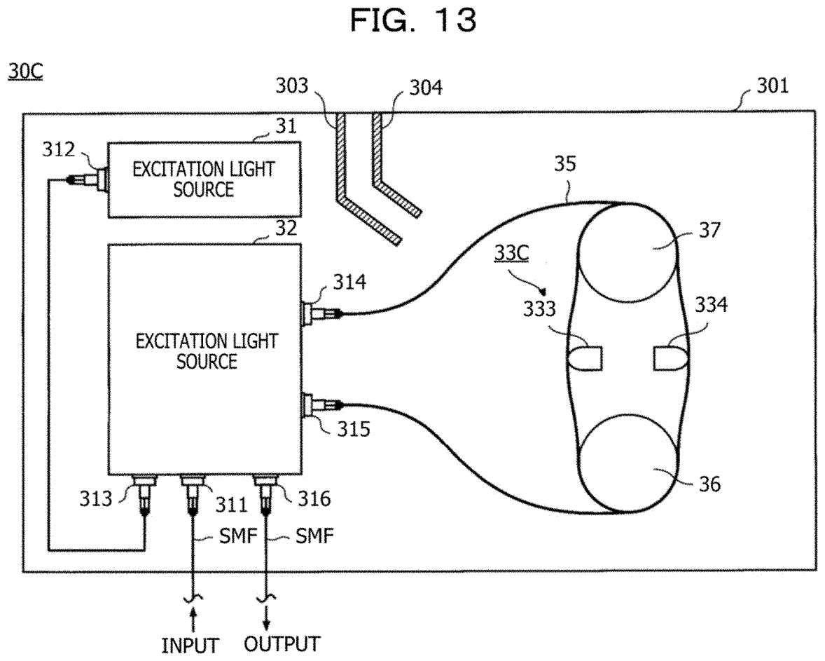

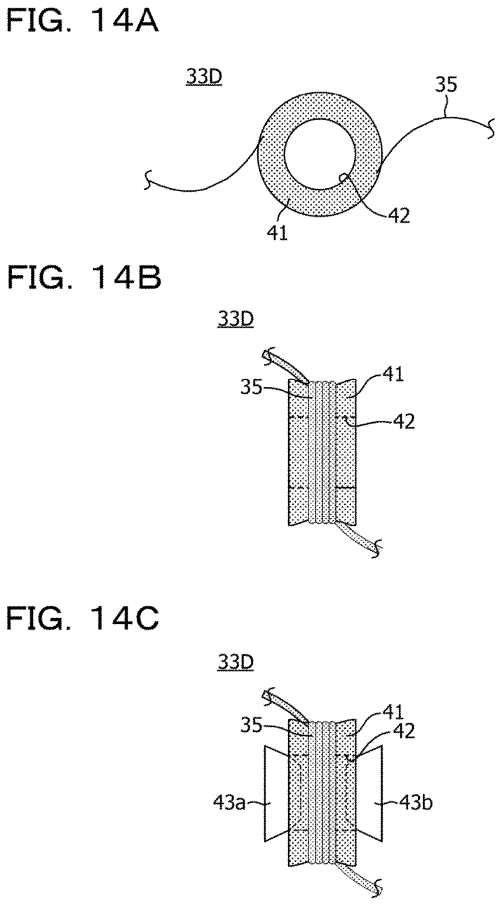

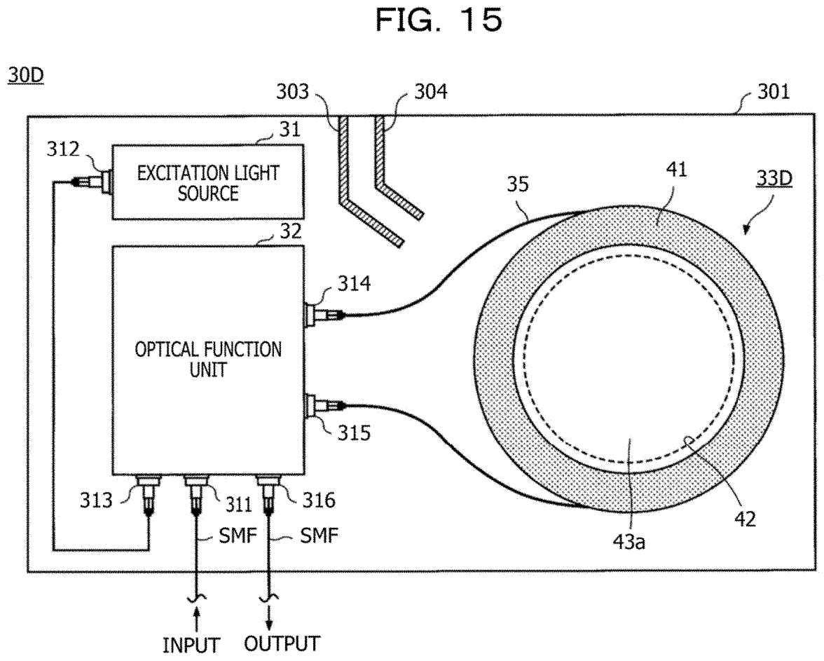

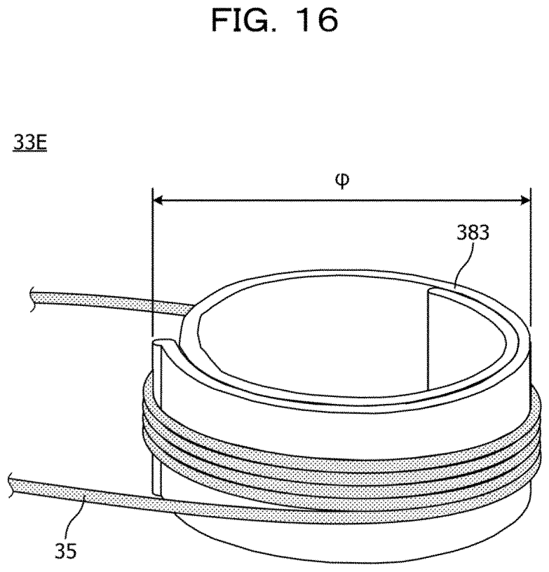

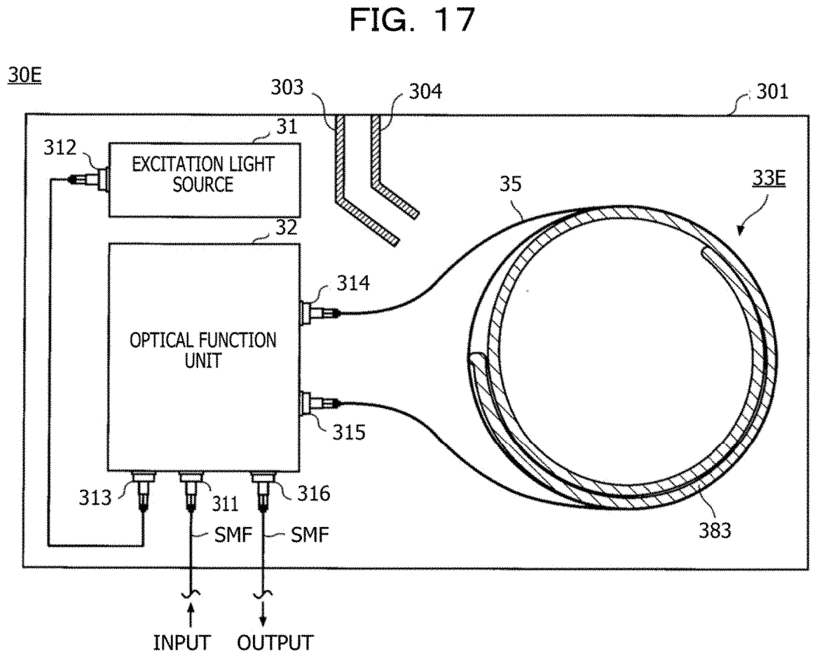

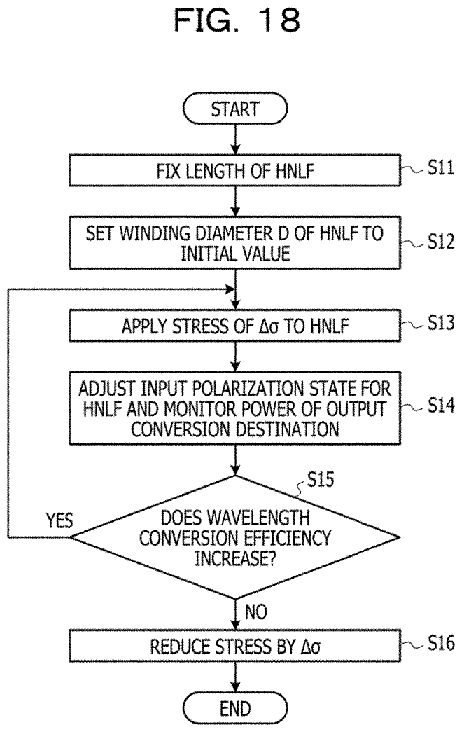

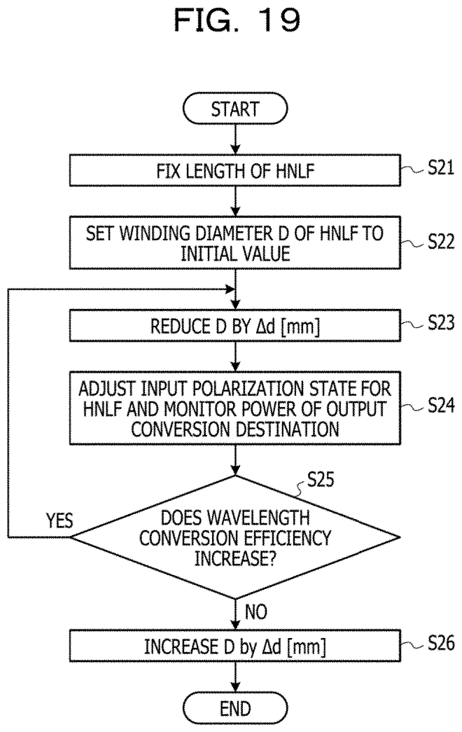

FIG. 5C is a schematic diagram illustrating wavelength conversion using two beams of parallel excitation light;

FIG. 6 is a diagram illustrating a first example of a stress application mechanism;

FIG. 7 is a diagram illustrating pressing of the optical fiber using wedges;

FIG. 8 is a schematic diagram of a wavelength converter in which the optical fiber and the stress application mechanism are packaged;

FIG. 9 is a diagram illustrating a second example of the stress application mechanism;

FIG. 10 is a diagram illustrating a configuration example of bobbins having variable diameters illustrated in FIG. 9;

FIG. 11 is a schematic diagram of a wavelength converter in which the optical fiber and the stress application mechanism of FIG. 9 are packaged;

FIG. 12 is a diagram illustrating a third example of the stress application mechanism;

FIG. 13 is a schematic diagram of a wavelength converter in which the optical fiber and the stress application mechanism of FIG. 12 are packaged;

FIG. 14A is diagrams illustrating a fourth example of the stress application mechanism;

FIG. 14B is diagrams illustrating a fourth example of the stress application mechanism;

FIG. 14C is diagrams illustrating a fourth example of the stress application mechanism;

FIG. 15 is a schematic diagram of a wavelength converter in which the optical fiber and the stress application mechanism of FIGS. 14A, 146, and 14C are packaged;

FIG. 16 is a diagram illustrating a fifth example of the stress application mechanism;

FIG. 17 is a schematic diagram of a wavelength converter in which the optical fiber and the stress application mechanism of FIG. 16 are packaged;

FIG. 18 is a flowchart of a method for adjusting the wavelength converter; and

FIG. 19 is a flowchart of a method for adjusting the wavelength converter.

### DESCRIPTION OF EMBODIMENTS

When monochromatic light is inputted to an HNLF having slight birefringence and an input wavelength changes, a polarization state of output light periodically changes. However, when a polarization state of the input light is in a unique state, the polarization state of the output light is uniform even though the input wavelength changes. The unique polarization state is a state in which two polarizations are orthogonal to each other, and is called a principal state of polarization (PSP).

The PSP is affected by birefringence of a medium. When the birefringence of the medium becomes high, the state of the PSP or an orientation in a Stokes space changes as light is propagated, and wavelength dependence appears.

In the wavelength conversion method in which bands including a plurality of wavelengths are collectively converted, such as between the L band and the C band and between the S band and the C band, the wavelength conversion efficiency is lowered due to the influence of the change of the PSP. It is desirable that the PSP be stable over the band of the input signal light.

Thus, the present invention is to provide a wavelength converter, a method, a communication system and more, in which the wavelength dependence of PSP is suppressed, and the conversion efficiency is improved.

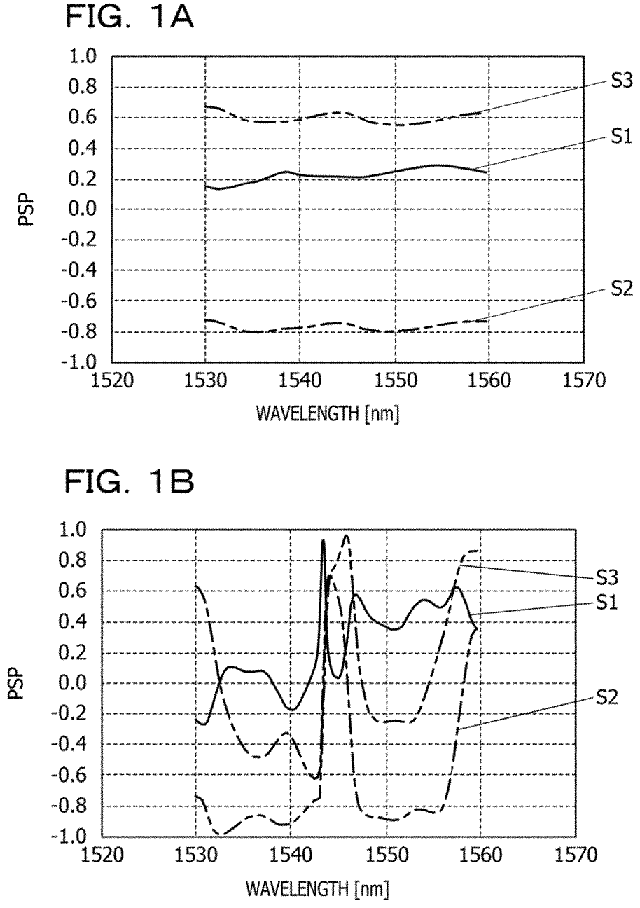

FIGS. 1A and 1B are diagrams for describing wavelength dependence of the PSP. A horizontal axis is a wavelength, and a vertical axis is a normalized PSP direction. The polarization state of the PSP is expressed by three Stokes parameters S1, S2, and S3. S1 indicates total intensity, S2 indicates a difference in intensity between a horizontal component and a vertical component, and S3 indicates a difference in intensity between a n/4 component and a −n/4 component.

FIG. 1A illustrates a state in which the wavelength dependence of the PSP is small. Even though the wavelength changes, the PSP is stable in all the Stokes parameters S1 to S3.

FIG. 1B illustrates a state in which the wavelength dependence of the PSP is large. In the same wavelength band as in FIG. 1A, the PSP greatly varies in all the Stokes parameters S1 to S3.

The PSP is affected by birefringence of a medium. When the birefringence of the medium becomes high beyond an allowable range, a direction of the PSP changes as the light is propagated, and the wavelength dependence appears. When the birefringence of the medium becomes high, a differential group delay (DGD) also becomes large. When wavelength conversion is performed by causing excitation light to be incident and using a nonlinear optical effect of the medium, a propagation speed is shifted between the polarizations, interaction is reduced, and wavelength conversion efficiency is reduced.

In an embodiment, the wavelength dependence of the PSP in the HNLF is reduced, and thus, the wavelength conversion efficiency is improved. The inventors have found that the wavelength dependence of the PSP may be reduced by applying, to a NON-PMF type optical fiber, optimum birefringence to the extent that the wavelength conversion efficiency does not deteriorate. Optimum stress is applied to the optical fiber, for example, by slightly reducing a bending radius of the optical fiber having the nonlinear optical effect, and thus, appropriate birefringence is applied to the optical fiber. The applied stress is adjusted so as not to exceed an allowable loss of the optical fiber, and is adjusted such that an output power of the wavelength-converted light is maximized.

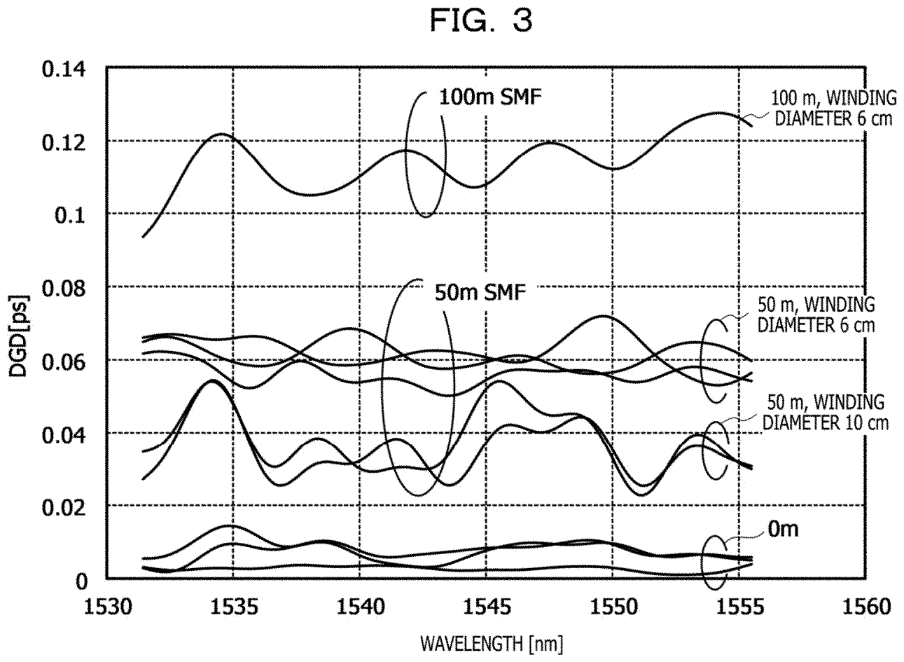

The inventors have found that there is an appropriate winding diameter depending on a length of the optical fiber to be used. Details thereof will be described with reference to FIG. 3 and subsequent drawings.

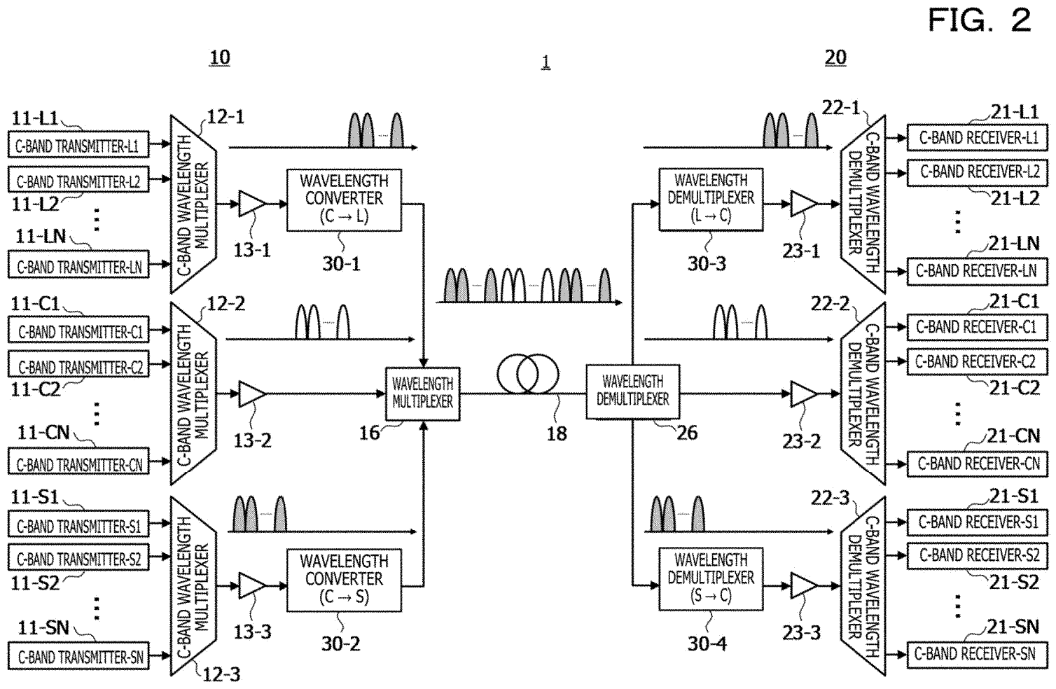

FIG. 2 is a schematic diagram of an optical transmission system 1 to which a wavelength converter according to the embodiment is applied. The optical transmission system 1 carries out, for example, WDM optical communication. The optical transmission system 1 includes an optical communication device 10 on a transmission side, an optical communication device 20 on a reception side, and an optical transmission path 18 coupling these optical communication devices 10 and 20. Both the optical communication device 10 and the optical communication device 20 have both a transmission function and a reception function, and have the same configuration. For the sake of convenience in description, a function on the transmission side of the optical communication device 10 and a function on the reception side of the optical communication device 20 will be described as examples.

The optical communication device 10 includes optical transmitters 11-L1 to 11-LN included in a first group, optical transmitters 11-C1 to 11-CN included in a second group, and optical transmitters 11-S1 to 11-SN included in a third group (hereinafter, referred to collectively as “optical transmitters 11” as appropriate). These optical transmitters 11 are each a photoelectric conversion front end circuit of an optical transponder, for example. The optical transmitters 11 have the same configuration, and output signals having a wavelength channel of a C band (1530 to 1565 nm) (which are referred to as “C-band transmitters” in the drawings).

Output light of the optical transmitters 11-L1 to 11-LN in the first group is multiplexed by a first wavelength multiplexer 12-1. Output light of the optical transmitters 11-C1 to 11-CN in the second group is multiplexed by a second wavelength multiplexer 12-2. Output light of the optical transmitters 11-S1 to 11-SN in the third group is multiplexed by a third wavelength multiplexer 12-3. The first wavelength multiplexer 12-1 to the third wavelength multiplexer 12-3 have the same function and configuration and multiplex inputted signals of multiple wavelength channels and output resultant signals.

Output of the first wavelength multiplexer 12-1 is amplified by a first optical amplifier 13-1. Output of the second wavelength multiplexer 12-2 is amplified by a second optical amplifier 13-2. Output of the third wavelength multiplexer 12-3 is amplified by a third optical amplifier 13-3. The first optical amplifier 13-1 to the third optical amplifier 13-3 have the same function and configuration and amplify multiplexed optical signals of the C-band.

The C-band signal light amplified by the first optical amplifier 13-1 is subjected to wavelength conversion by a first wavelength converter 30-1 and inputted to a wavelength multiplexer 16. In this example, the C-band signals are converted to L-band signals all together.

The C-band signal light amplified by the third optical amplifier 13-3 is subjected to wavelength conversion by a second wavelength converter 30-2 and inputted to the wavelength multiplexer 16. In this example, the C-band signals are converted to S-band signals all together.

The C-band signal light amplified by the second optical amplifier 13-2 is not subjected to wavelength conversion and is inputted to the wavelength multiplexer 16 as it is.

The wavelength multiplexer 16 multiplexes the L-band signal light, the C-band signal light, and the S-band signal light and outputs the resultant optical signal to the optical transmission path 18. This optical signal contains wavelength channels from the L-band to the S-band and optical communication over a wide band is carried out. The optical signal is propagated through the optical transmission path 18 and is received by the optical communication device 28.

In the optical communication device 20, the received optical signal is demultiplexed into L-band signal light, C-band signal light, and S-band signal light by a wavelength demultiplexer 26. The L-band signal light is converted to C-band signal light by a third wavelength converter 30-3, is amplified by an optical amplifier 23-1, and is demultiplexed into different wavelength channels by a first wavelength demultiplexer 22-1.

The S-band signal light is converted to C-band signal light by a fourth wavelength converter 30-4, is amplified by an optical amplifier 23-3, and is demultipiexed into different wavelength channels by a third wavelength demultiplexer 22-3. The C-band signal light is not subjected to wavelength conversion, is amplified by an optical amplifier 23-2 as it is, and is demultipiexed into different wavelength channels by a second wavelength demultiplexer 22-2.

The optical amplifiers 23-1 to 23-3 have the same function and configuration. The wavelength demultiplexers 22-1 to 22-3 have the same function and configuration and demultiplex C-band signal light into different wavelength channels, respectively.

The beams of signal light demultiplexed by the first wavelength demultiplexer 22-1 are supplied to optical receivers 21-L1 to 21-LN in a first group. The beams of signal light demultiplexed by the second wavelength demultiplexer 22-2 are supplied to optical receivers 21-C1 to 21-CN in a second group. The beams of signal light demultiplexed by the third wavelength demultiplexer 22-3 are supplied to optical receivers 21-S1 to 21-SN in a third group. The optical receivers 21-L1 to 21-LN, the optical receivers 21-C1 to 21-CN, and the optical receivers 21-S1 to 21-SN are referred to collectively as “optical receivers 21” as appropriate.

These optical receivers 21 are each a photoelectric conversion front end circuit of an optical transponder, for example. The optical receivers 21 have the same configuration and convert light having a wavelength channel of the C band (1530 to 1565 nm) to electric signals (which are referred to as “C-band receivers” in the drawings).

This transmission system (communication system) does not use optical components for individual bands but uses common optical transmitters and receivers, wavelength multiplexers and demultiplexers, optical amplifiers, and the like. Using the wavelength converters 30-1 to 30-4 makes it possible to expand optical communication bands using the existing optical components.

FIG. 3 is a graph illustrating changes in wavelength dependence of a DGD due to changes in the length and winding diameter of the optical fiber. For example, when attention is paid to a single mode fiber (SMF) having a length of 50 m, it is seen that the DGD may be increased and the wavelength dependence thereof may be reduced by reducing the winding diameter in the optical fiber having the same length. However, when the winding diameter becomes too small, a bending loss increases. The birefringence becomes high beyond the allowable range, the DGD further increases, and the wavelength dependence becomes strong.

When an SMF having a length of 100 m is compared with the fiber having the length of 50 m, the DGD increases, and the wavelength dependence increases even though these optical fibers have a diameter of 6 cm. When the fiber length is long, the winding diameter is set to be larger than when the fiber length is short, and thus, the DGD may be adjusted to an appropriate value. Accordingly, the wavelength dependence may be reduced.

The adjustment of the winding diameter of the optical fiber is an example in which the birefringence is adjusted by adjusting the stress applied to the nonlinear optical fiber. As will be described later, the birefringence may be adjusted by adjusting tension of the optical fiber.

When the length of the nonlinear optical fiber to be used in the wavelength converter is determined, a winding diameter or a curvature suitable for the determined length, for example, a winding diameter or a curvature at which the wavelength dependence of the DGD becomes low is selected as an initial value. Test signal light and excitation light are caused to be incident on an optical fiber, and stress is gradually applied to the wound optical fiber while monitoring an output power of converted light. When the output power of the converted light is maximized, a stress value at this time is fixed, and the wavelength converter is packaged.

Since the optical fiber is wound, slight stress or strain occurs in the optical fiber. The birefringence is finely adjusted by applying additional stress to the wound optical fiber and changing an initial stress or strain state. The wavelength conversion efficiency may be improved in the optical communication of a system for converting beams of signal light including a plurality of wavelengths all together by applying the optimum stress at which the wavelength dependence of the PSP is minimized to the optical fiber.

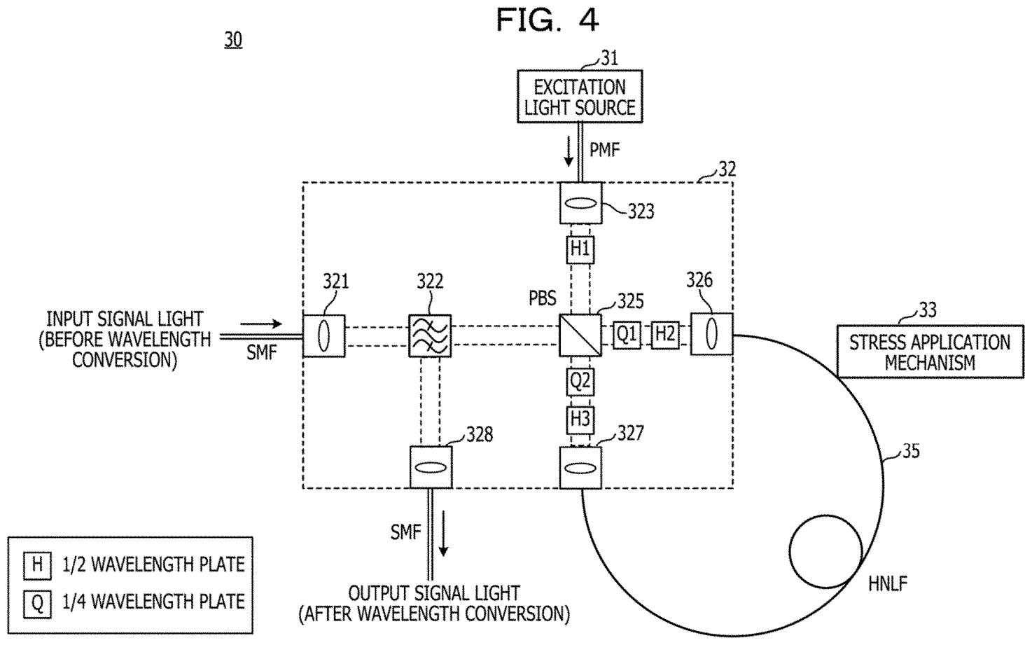

FIG. 4 is a schematic diagram of a wavelength converter 30 of the embodiment. The wavelength converter 30 includes an excitation light source 31, an optical function unit 32, a stress application mechanism 33, and an optical fiber 35 that is a nonlinear optical medium. The optical fiber 35 is wound with a predetermined radius of curvature, and both ends thereof are optically coupled to the optical function unit 32.

The stress application mechanism 33 applies stress to the wound optical fiber 35. A stress application direction is a direction crossing an optical axis or a winding direction of the optical fiber. When the optical fiber is wound in a circular shape, the stress may be applied in a winding diameter direction. When the optical fiber is wound in a racetrack shape by using two bobbins, the stress may be applied in a direction crossing tension of the optical fiber. The stress is applied by reducing the radius of curvature of the winding of the optical fiber or pressing the suspended optical fiber with a pressing tool such as a wedge or a pin. The stress applied to the optical fiber 35 is adjusted and fixed to an optimum value in advance such that the birefringence occurring in the optical fiber 35 minimizes the wavelength dependence of the PSP.

Signal light having a wavelength λ_{L} inputted to the wavelength converter 30 is collimated by a collimator 321, is transmitted through a wavelength filter 322, and is incident on a polarization beam splitter (PBS) 325. Excitation light having a wavelength λ_{P} outputted from the excitation light source 31 is collimated by a collimator 323, is applied a phase difference of a half wavelength by a ½ wavelength plate (H1), and is spatially coupled to the PBS 325.

In the PBS 325, the polarization-split excitation light is multiplexed with each of polarization components (TE component and TM component) of the signal light, polarization state directions of beams of the multiplexed light are aligned by a ¼ wavelength plate (Q1) and a ½ wavelength plate (H2), and the beams are distributed and inputted to two main axes of the optical fiber 35 via a collimator 326, Due to the nonlinear optical effect of the optical fiber, the signal light and the excitation light interact with each other, and a light component having a wavelength λ_{C} different from any wavelength is generated. This light component is called converted light.

Light including the signal light, the excitation light, and the converted light is guided to a ½ wavelength plate (H3) by a collimator 327, is transmitted through a ¼ wavelength plate (Q2), and is spatially coupled to the PBS 325. A polarized component reflected by the PBS 325 is incident on the wavelength filter 322, and the converted light is extracted by the wavelength filter 322. The converted light is incident on an output optical fiber via a collimator 328 and is outputted to the outside.

FIGS. 5A to 5C are schematic diagrams illustrating the wavelength conversion due to the interaction with the excitation light. A single beam of excitation light is used in FIG. 5A, and two beams of excitation light of which polarization directions are orthogonal to each other are used in FIGS. 5B and 5C.

In the wavelength conversion using the single beam of excitation light of FIG. 5A, excitation light having the same polarization direction as that of input signal light is incident on a nonlinear optical medium. Converted light having a wavelength different from those of both the input signal light and the excitation light is generated due to the interaction between the signal light and the excitation light in the nonlinear optical medium. In the embodiment, the stress is applied to the optical fiber 35 which is the nonlinear optical medium such that optimum birefringence occurs, and the converted light with less waveform deterioration is obtained so as to correspond to a wavelength band of the input signal light.

In FIG. 5B, first excitation light v_{P1} having a frequency higher than that of target converted light and second excitation light v_{P2} having a frequency lower than that of input signal light are used. Polarization directions of the first excitation light v_{P1} and the second excitation light v_{P2} are orthogonal to each other. A polarization direction of the input signal light is the same as the polarization direction of the first excitation light v_{P1} and is orthogonal to the polarization direction of the second excitation light v_{P2}. A polarization direction of the generated converted light is orthogonal to the polarization direction of the input signal light and is also orthogonal to the polarization direction of the first excitation light v_{P1}.

As illustrated in FIG. 5B, even when the two beams of excitation light having different wavelengths are used, the stress is applied to the optical fiber 35 such that the optimum birefringence occurs, and the wavelength dependence of the PSP is suppressed. As a result, the converted light with less waveform deterioration is obtained over the wavelength band of the input signal light.

In FIG. 5C, first excitation light v_{P1} near a central wavelength of target converted light and second excitation light v_{P2} near a central wavelength of input signal light are used. Polarization directions of the first excitation light v_{P1} and the second excitation light v_{P2} are the same. A polarization direction of the input signal light and a polarization direction of the second excitation light v_{P2} are orthogonal to each other. A polarization direction of generated converted light is the same as the polarization direction of the input signal light and is orthogonal to the polarization direction of the first excitation light v_{P1}.

As illustrated in FIG. 5C, even when beams of excitation light having two different wavelengths are used, the stress is applied to the optical fiber 35 such that the optimum birefringence occurs, and the wavelength dependence of the PSP is suppressed. As a result, the converted light with less waveform deterioration is obtained over the wavelength band of the input signal light.

### Configuration Example 1 of Stress Application Mechanism

FIG. 6 is a diagram illustrating a first example of the stress application mechanism. A stress application mechanism 33A includes two bobbins 36 and 37 around which the optical fiber 35 is wound, and wedges 331 and 332 for applying the stress to the wound optical fiber 35 in a direction crossing the optical axis or the winding direction. The optical fiber 35 wound around outer peripheries of the bobbins 36 and 37 is suspended between the bobbins 36 and 37 with uniform tension. The stress is applied to the optical fiber 35 by pressing the wedges 331 and 332 against the optical fiber 35 stretched between the bobbins 36 and 37.

As illustrated in FIG. 7, surfaces of the wedges 331 and 332 that come into contact with the optical fiber 35 are preferably curved. This is because damage for the optical fiber 35 is small. The output power of the converted light output from the optical fiber 35 is monitored while changing the stress applied to the optical fiber 35 by the wedges 331 and 332.

As an example, the stress applied to the optical fiber 35 may gradually increase by moving the wedges 331 and 332 toward each other above a slide rail 302 with a lock. When the length of the optical fiber 35 to be used is determined, the winding diameter or curvature corresponding to the determined length is roughly selected. The stress is gradually applied to the optical fiber 35 wound with the selected winding diameter, and thus, the birefringence of the optical fiber 35 changes. Accordingly, the wavelength dependence of the DGD, for example, the wavelength dependence of the PSP changes. When the wavelength dependence of the DGD is minimized, the application of the stress is stopped and the wedges 331 and 332 are fixed.

Other pressing tools such as pins and cylindrical rods may be used instead of the wedges 331 and 332. The stress may be gradually applied to the optical fiber 35 by pressing a curved side surface of the pin or rod against the optical fiber 35.

A screw type wedge of which a position changes by rotation of a driver may be used instead of the slide rail 302. In this case, a tip of a screw abutting on the optical fiber 35 is formed as a curved surface. Positions of the wedges 331 and 332 may be fixed by providing an adhesive layer of an ultraviolet curing resin on bottom surfaces of the wedges 331 and 332, pressing the optical fiber 35 while gradually sliding the wedges 331 and 332, and irradiating the wedges with ultraviolet rays when the output power of the converted light is maximized.

FIG. 8 is a schematic diagram of a wavelength converter 30A in which the optical fiber 35 and the stress application mechanism 33A are packaged. The wavelength converter 30A includes the excitation light source 31, the optical function unit 32, the optical fiber 35 optically coupled to the optical function unit 32, and the stress application mechanism 33A, and these components are arranged in a package 301. Further, the package 301 includes a Thermistor wire 303 and Peltier wire (or Heater wire) 304.

The Thermistor wire 303 is wire using Thermistor that being is a resistor whose electrical resistance changes greatly with temperature changes. The Peltier wire 304 is wire using elements (or electronic components) that may generate heater by thermoelectric effect.

The optical fiber 35 is wound along the outer peripheries of the bobbins 36 and 37. A distance between centers of the bobbins 36 and 37 is, for example, several centimeters. The wedges 331 and 332 abut on the optical fiber 35 suspended between the bobbins 36 and 37, and predetermined stress is applied to the optical fiber 35.

Both ends of the optical fiber 35 are coupled to the optical function unit 32 by ports 314 and 315. For example, as illustrated in FIG. 4, the optical function unit 32 includes optical components such as the plurality of collimators, the wavelength filter 322, the PBS 325, the ½ wavelength plate, and the ¼ wavelength plate.

The optical function unit 32 includes an input port 311 into which the signal light is inputted, an input port 313 into which the excitation light is inputted, and an output port 316 from which the converted light is outputted. The input port 313 of the optical function unit is coupled to an output port 312 of the excitation light source 31.

Although the single beam of excitation light is used in this example, the two beams of excitation light may be inputted to the optical function unit 32 by using the two excitation light sources as illustrated in FIG. 5B or 5C.

In the wavelength converter 30A, the optimum stress is applied to the optical fiber 35, and the wavelength dependence of the DGD, for example, the wavelength dependence of the PSP is suppressed to the minimum. Even when beams of signal light including many wavelengths are converted all together, waveform deterioration is suppressed, and quality of converted light is improved.

### Configuration Example 2 of Stress Application Mechanism

FIG. 9 is a diagram illustrating a second example of the stress application mechanism. A stress application mechanism 33B includes two bobbins 38 and 39 around which the optical fiber 35 is wound, and the wedges 331 and 332 for applying the stress to the wound optical fiber 35 in a direction crossing the optical axis or the winding direction. Diameters of the bobbins 38 and 39 are variable.

The optical fiber 35 wound around outer peripheries of the bobbins 38 and 39 is suspended between the bobbins 38 and 39 with uniform tension. The stress is applied to the optical fiber 35 by pressing the wedges 331 and 332 against the optical fiber 35 stretched between the bobbins 38 and 39. Tension of the optical fiber 35 increases, and thus, the diameters of the bobbins 38 and 39 decrease.

When the diameters of the bobbins 38 and 39 become small, a winding diameter of the optical fiber 35 becomes small (the curvature of the winding becomes large), and the birefringence becomes high. When a change in the birefringence is within a certain range, the wavelength dependence of the DGD may be reduced without increasing the bending loss. However, when this change exceeds the certain range, the birefringence is excessive, and the wavelength dependence of the DGD rapidly increases.

The wedges 331 and 332 are fixed when the output power is maximized by changing the stress applied to the optical fiber 35 while monitoring the output power of the converted light.

FIG. 10 illustrates spiral bobbins 381 and 391 as an example of the bobbins 38 and 39 having the variable diameters. When the wedges 331 and 332 are pressed against the optical fiber 35 and the tension of the optical fiber 35 increases, the spiral bobbins 381 and 391 contract inward, and the diameters thereof become small. As the diameters of the bobbins 381 and 391 become small, the stress of the optical fiber 35 becomes strong, and the birefringence becomes high. With this configuration, an optimum stress position at which the output power of the converted light is maximized may be determined.

FIG. 11 is a schematic diagram of a wavelength converter 30B in which the optical fiber 35 and the stress application mechanism 33B are packaged. The wavelength converter 30B includes the excitation light source 31, the optical function unit 32, the optical fiber 35 optically coupled to the optical function unit 32, and the stress application mechanism 33B, and these components are arranged in the package 301. Further, the package 301 includes a Thermistor wire 303 and Peltier wire (or Heater wire) 304.

The optical fiber 35 is wound along the outer peripheries of the bobbins 38 and 39. A distance between centers of the bobbins 38 and 39 is, for example, several centimeters. The wedges 331 and 332 abut on the optical fiber 35 suspended between the bobbins 38 and 39, and the diameters of the bobbins 38 and 39 become small depending on the stress applied to the optical fiber 35. Both the ends of the optical fiber 5 are coupled to the optical function unit 32 by the ports 314 and 315.

Other configurations of the wavelength converter 30B are similar to those of the wavelength converter 30A, and redundant description thereof will be omitted. In the wavelength converter 30B, the optimum stress is applied to the optical fiber 35, and the wavelength dependence of the DGD, for example, the wavelength dependence of the PSP is suppressed to the minimum. Even when beams of signal light including many wavelengths are converted all together, waveform deterioration is suppressed, and quality of converted light is improved.

### Configuration Example 3 of Stress Application Mechanism

FIG. 12 is a diagram illustrating a third example of the stress application mechanism. A stress application mechanism 33C includes the two bobbins 36 and 37 around which the optical fiber 35 is wound, and wedges 333 and 334 for applying the stress to the wound optical fiber 35 in the direct on crossing the optical axis or the winding direction.

Although it has been described in Configuration Example 1 of FIG. 6 that the wedges 331 and 332 are arranged on an outside of the winding of the optical fiber 35 and press the optical fiber 35 from the outside, the wedges 333 and 334 are arranged on an inside of the winding of the optical fiber 35 and press the optical fiber 35 from the inside in FIG. 12.

The optical fiber 35 wound around the outer peripheries of the bobbins 36 and 37 is suspended between the bobbins 36 and 37 with uniform tension. The stress is applied to the optical fiber 35 by pressing the wedges 333 and 334 against the optical fiber 35 stretched between the bobbins 36 and 37 from the inside of the winding.

When the stress is applied to the optical fiber 35, the birefringence of the optical fiber 35 slightly increases. When the change in the birefringence is within the certain range, the birefringence becomes high, and thus, the wavelength dependence of the DGD becomes low. However, when this change exceeds the certain range, the birefringence is excessive, and the wavelength dependence of the DGD rapidly increases.

The wedges 333 and 334 are fixed when the output power is maximized by changing the stress applied to the optical fiber 35 while monitoring the output power of the converted light.

FIG. 13 is a schematic diagram of a wavelength converter 30C in which the optical fiber 35 and the stress application mechanism 33C are packaged. The wavelength converter 30C includes the excitation light source 31, the optical function unit 32, the optical fiber 35 optically coupled to the optical function unit 32, and the stress application mechanism 33C, and these components are arranged in the package 301. Further, the package 341 includes a Thermistor wire 303 and Peltier wire (or Heater wire) 304.

The optical fiber 35 is wound along the outer peripheries of the bobbins 36 and 37. The distance between the centers of the bobbins 36 and 37 is, for example, several centimeters. The stress is applied to the optical fiber 35 by arranging the wedges 333 and 334 on the inside of the winding of the optical fiber 35 and causing the wedges 333 and 334 to abut on the optical fiber 35 suspended between the bobbins 36 and 37. Both the ends of the optical fiber 35 are coupled to the optical function unit 32 by the ports 314 and 315.

Other configurations of the wavelength converter 30C are the same as those of the wavelength converters 30A and 30B, and redundant description thereof will be omitted. In the wavelength converter 30C, the optimum stress is applied from the inside of the winding of the optical fiber 35, and the wavelength dependence of the DGD, for example, the wavelength dependence of the PSP is suppressed to the minimum. Even when beams of signal light including many wavelengths are converted all together, waveform deterioration is suppressed, and quality of converted light is improved.

### Configuration Example 4 of Stress Application Mechanism

FIGS. 14A, 14B, and 14C are diagrams illustrating a fourth example of the stress application mechanism. A stress application mechanism 33D includes a hollow bobbin 41 made of an elastic material, and tapered wedges 43a and 43b inserted into a hollow 42 of the hollow bobbin 41. FIG. 14A is a top view of the hollow bobbin 41, and FIGS. 148 and 14C are side views thereof.

The optical fiber 35 is wound around the hollow bobbin 4L The hollow bobbin 41 having an appropriate diameter corresponding to a total length of the optical fiber 35 is selected. A state illustrated in FIG. 148 in which the tapered wedges 43a and 43b are not inserted is an initial state.

As illustrated in FIG. 14C, when the tapered wedges 43a and 43b are inserted into the hollow 42 of the hollow bobbin 41, a diameter of the hollow bobbin 41 made of the elastic material increases depending on the amount of insertion. The diameter of the hollow bobbin 41 increases, and thus, the stress is applied to the optical fiber 35 from the inside of the winding of the optical fiber 35.

The birefringence of the optical fiber 35 slightly increases due to the stress applied to the optical fiber 35. When the change in the birefringence is within the certain range, the birefringence becomes high, and thus, the wavelength dependence of the DGD becomes low. However, when this change exceeds the certain range, the birefringence is excessive, and the wavelength dependence of the DGD rapidly increases.

The wedges 43a and 43b are gradually inserted into the hollow 42 while monitoring the output power of the converted light, and the stress applied to the optical fiber 35 is changed. When the output power of the converted light is maximized, the wedges 43a and 43b are fixed.

FIG. 15 is a schematic diagram of a wavelength converter 30D in which the optical fiber 35 and the stress application mechanism 33D are packaged. The wavelength converter 30D includes the excitation light source 31, the optical function unit 32, the optical fiber 35 optically coupled to the optical function unit 32, and the stress application mechanism 33D, and these components are arranged in the package 301. Further, the package 301 includes a Thermistor wire 303 and Peltier wire (or Heater wire) 304.

The optical fiber 35 is wound along an outer periphery of the hollow bobbin 41. The diameter of the hollow bobbin 41 is, for example, several centimeters. The wedges 43a and 43b (refer to see FIGS. 14A, 14B, and 14C) are inserted into the hollow 42 of the hollow bobbin 41 around which the optical fiber 35 is wound by a predetermined amount, and the stress is applied to the optical fiber 35. Both the ends of the optical fiber 35 are coupled to the optical function unit 32 by the ports 314 and 315.

Other configurations of the wavelength converter 30D are the same as those of the wavelength converters 30A to 30C, and redundant description thereof will be omitted. In the wavelength converter 30D, the optimum stress is applied from the inside of the winding of the optical fiber 35, and the wavelength dependence of the DGD, for example, the wavelength dependence of the PSP is suppressed to the minimum, Even when beams of signal light including many wavelengths are converted all together, waveform deterioration is suppressed, and quality of converted light is improved.

### Configuration Example 5 of Stress Application Mechanism

FIG. 16 is a diagram illustrating a fourth example of the stress application mechanism. A stress application mechanism 33E includes a spiral bobbin 383 having a variable diameter. The optical fiber 35 is wound around the bobbin 383. The bobbin 383 having an appropriate diameter is selected depending on the total length of the optical fiber 35 to be used. A diameter φ of the bobbin 383 before the optical fiber 35 is wound is an initial diameter.

When the optical fiber 35 is wound around a side surface of the spiral bobbin 383, a diameter of the bobbin 383 contracts by tension. Strength of the winding of the optical fiber 35 is fixed and the diameter of the bobbin 383 is fixed when the output power is maximized by monitoring the output power of the converted light while gradually increasing the tension when the optical fiber 35 is wound. The diameter of the bobbin 383 decreases, for example, the curvature of the winding becomes large, and thus, the birefringence of the optical fiber 35 slightly increases. Accordingly, the wavelength dependence of the DGD may be minimized.

FIG. 17 is a schematic diagram of a wavelength converter 30E in which the optical fiber 35 and the stress application mechanism 33E are packaged. The wavelength converter 30E includes the excitation light source 31, the optical function unit 32, the optical fiber 35 optically coupled to the optical function unit 32, and the stress application mechanism 33E, and these components are arranged in the package 301. Further, the package 301 includes a Thermistor wire 303 and Peltier wire (or Heater wire) 304.

The optical fiber 35 is wound along an outer periphery of the spiral bobbin 383 having the variable diameter. The diameter of the bobbin 383 is, for example, several centimeters. Both the ends of the optical fiber 35 are coupled to the optical function unit 32 by the ports 314 and 315.

Other configurations of the wavelength converter 30E are the same as those of the wavelength converters 30A to 30D, and redundant description thereof will be omitted. In the wavelength converter 30E, the winding diameter of the optical fiber 35 changes by the spiral bobbin 383, and thus, the optimum stress is applied to the optical fiber 35. Accordingly, the wavelength dependence of the DGD, for example, the wavelength dependence of the PSP is suppressed to the minimum. Even when beams of signal light including many wavelengths are converted all together, waveform deterioration is suppressed, and quality of converted light is improved.

FIG. 18 is a flowchart of a method for adjusting the wavelength converter 30. First, a length of the HNLF is fixed (S11). The length of the HNLF is selected so as to satisfy a phase matching condition depending on the wavelength band of the signal light, the number of included wavelengths, the wavelength of the excitation light, the wavelength of the target converted light, and the like.

A winding diameter D of the HNLF is set to an initial value (S12). The initial value D of the winding diameter is a winding diameter roughly selected such that the wavelength dependence of the DGD becomes low depending on the length of the HNLF. The winding diameter may be associated with the length of the HNLF in advance.

A stress of Δσ is applied to the wound HNLF (S13). Any of configuration Examples 1 to 5 of the stress application mechanism may be used as the method for applying the stress of Δσ.

An input polarization state for the HNLF is adjusted and a power of output converted light is monitored (S14), and it is determined whether or not the wavelength conversion efficiency increases (S15). For example, whether or not the wavelength conversion efficiency increases may be determined by determining whether or not a ratio of the power of the output converted light to a power of the input signal light increases.

When the wavelength conversion efficiency increases (YES in S15), the processing returns to step S13, and the application of the stress of Δσ is continued. S13 to S15 are repeated until the wavelength conversion efficiency no longer increases. When the wavelength conversion efficiency does not increase (NO in S15), the stress is reduced by Δσ (S16), and the processing is terminated.

FIG. 19 illustrates an adjustment flow of the winding diameter of the HNLF as an example of the adjustment of the stress to the HNLF. First, the length of the HNLF is fixed (S21). The length of the HNLF is selected so as to satisfy a phase matching condition depending on the wavelength band of the signal light, the number of included wavelengths, the wavelength of the excitation light, the wavelength of the target converted light, and the like.

The winding diameter D of the HNLF is set to an initial value (S22). The initial value D of the winding diameter is a winding diameter roughly selected such that the wavelength dependence of the DGD becomes low depending on the length of the HNLF. The winding diameter may be associated with the length of the HNLF in advance.

The diameter D of the wound HNLF is reduced by Δd (mm) (S23). Any of Configuration Examples 2 and 4 to 5 of the stress application mechanism may be used to decrease Δd.

The input polarization state for the HNLF is adjusted and the power of the output converted light is monitored (S24), and it is determined whether or not the wavelength conversion efficiency increases (S25). For example, whether or not the wavelength conversion efficiency increases may be determined by determining whether or not a ratio of the power of the output converted light to a power of the input signal light increases.

When the wavelength conversion efficiency increases (YES in S25), the processing returns to step S23, and the reduction of the diameter of Δd is continued. S23 to S25 are repeated until the wavelength conversion efficiency no longer increases. When the wavelength conversion efficiency does not increase (NO in S25), the winding diameter D of the HNLF is increased by Δd (S26), and the processing is terminated.

According to this method, the wavelength dependence of the DGD or the PSP may be minimized by applying the optimum stress to the HNLF, and thus, the wavelength conversion efficiency may be improved. The HNLF is housed in the package together with the optical function unit in an optimum stress state, and may be incorporated into the optical transmission system 1. The optical communication device 10 on the transmission side converts signal light having a first wavelength band to signal light having a second wavelength band by using the wavelength converter 30, and outputs the converted light to the optical transmission path. The optical communication device 20 on the reception side converts the received signal having the second wavelength band into the signal having the first wavelength band by using the wavelength converter 30, and processes the signal. The performance and reliability of the optical transmission system 1 are improved, and high-efficiency optical communication is realized.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wavelength converter comprising:
an input port;
an optical fiber configured to cause a signal light and an excitation light to interact with each other due to a nonlinear optical effect, the signal light and the excitation light being input to the input port;
a stress application mechanism configured to apply stress in a direction crossing a winding direction of the optical fiber; and
an output port configured to output a converted light having a wavelength different from wavelengths of the signal light and the excitation light.

2. The wavelength converter according to claim 1,
wherein the stress applied to the optical fiber by the stress application mechanism is fixed to a value at which an output power of the converted light is maximized.

3. The wavelength converter according to claim 1,
wherein the stress application mechanism includes a pair of bobbins, and a pressing tool that applies the stress to the optical fiber suspended between the pair of bobbins in a direction orthogonal to the winding direction.

4. The wavelength converter according to claim 3,
wherein the pressing tool is arranged on an outside of winding of the optical fiber, and applies the stress to the optical fiber from the outside of the winding.

5. The wavelength converter according to claim 3,
wherein the pressing tool is arranged on an inside of winding of the optical fiber, and applies the stress to the optical fiber from the inside of the winding.

6. The wavelength converter according to claim 1,
wherein the stress application mechanism is a bobbin having a variable diameter, and the stress applied to the optical fiber wound around the bobbin is adjusted by changing the diameter of the bobbin.

7. The wavelength converter according to claim 1,
wherein the stress application mechanism includes a hollow bobbin made of an elastic material, and a tapered member inserted into a hollow of the hollow bobbin, and
the stress applied to the optical fiber wound around the hollow bobbin is adjusted by changing an amount of insertion of the tapered member into the hollow.

8. An optical communication system comprising:
a first communication device; and
a second communication device that communicates with the first communication device,
wherein the first communication device includes a first wavelength converter configured to convert signal light having a first wavelength band to signal light having a second wavelength band different from the first wavelength band, and
the first wavelength converter includes:
an optical fiber configured to cause the signal light and excitation light to interact with each other due to a nonlinear optical effect,
a stress application mechanism configured to apply stress in a direction crossing a winding direction of the optical fiber, and
an output port configured to output converted light having a wavelength different from wavelengths of the signal light and the excitation light.

9. The optical communication system according to claim 8,
wherein the second communication device includes a second wavelength converter configured to convert the signal light having the second wavelength band to the signal light having the first wavelength band.

10. A method for adjusting a wavelength converter, the method comprising:
determining a total length of an optical fiber having a nonlinear optical effect;
winding the optical fiber with a diameter corresponding to the total length;
causing signal light and excitation light to be incident on the optical fiber while applying stress to the optical fiber in a direction crossing a winding direction, and monitoring a power of converted light output from the optical fiber; and
fixing the stress when the power is maximized.
